(19) United States
(12) Patent Application Publication
(10) Pub. No.: US 2009/0320632 A1
(43) Pub. Date: Dec. 31, 2009

(54) MARKING SCHEME FOR A GEAR MESHING ARRANGEMENT TO ENSURE PROPER ASSEMBLY THEREOF

(75) Inventors: Brett A. HEALD, Indianapolis, IN (US); Bhavin PARIKH, Greenwood, IN (US)

Correspondence Address: SAWYER LAW GROUP PC, 2465 E. Bayshore Road, Suite No. 406, PALO ALTO, CA, 94303, US

(73) Assignee: Cummins Intellectual Properties, Inc., Minneapolis, MN (US)

(21) Appl. No.: 12/163,841

(22) Filed: Jun. 27, 2008

(51) Int. Cl. F16H 55/08

(52) U.S. Cl. 74/457

(57) ABSTRACT

A gear meshing system is disclosed. The gear meshing system includes a pair of gears engaged with each other through a first plurality and a second plurality of teeth thereon. Each gear has a mark which is oriented in a predetermined relationship with a timing slot on the gear. Each gear of the pair of gears is identical to the other. Accordingly, by utilizing a marking scheme in accordance with the present invention the same gear part can be used with multiple shafts and thereby assure accurate meshing/timing upon assembly. Accordingly, the need for additional part numbers will be minimized and excessive part proliferation will be avoided.

### FIELD OF THE INVENTION

The present invention relates generally to gear assemblies and more particularly to ensuring proper assembly of a gear meshing arrangement.

### BACKGROUND OF THE INVENTION

A gear is a component within a transmission device that transmits rotational force to another gear or device. Typically, gears are utilized in gear meshing arrangements in a variety of environments.

For example, a gear meshing arrangement is utilized in an internal combustion engine for engaging a camshaft with a crankshaft. An internal combustion engine requires typically a multiple gear set to operate the camshafts. In this type of system typically one gear set (two gears) operate two cam shafts. Even though the gear ratio is 1:1 a generic meshing marking scheme for assembly requires at least two separate part numbers in each meshing gear set. FIG. 1 illustrates an enlarged view of a conventional marking scheme for a gear meshing arrangement. The arrangement 10 includes a pair of gears 12 and 14 engaged with each other. The conventional marking scheme typically a dot 16a on the tooth 18 of one gear 12 and a dot 16b on the fillet 20 of the second gear 14 provide orientation and timing during assembly of the gear meshing arrangement.

With this conventional marking scheme, each of the gears 12 and 14 have separate part numbers (one for intake and one for exhaust) although the gears are otherwise identical. The separate part numbers are required because the meshing pattern requires a specific tooth alignment along with a specific mark alignment. This in turn results in part proliferation and also results in adverse assembly/service issues.

For example, this type of marking scheme introduces a higher probability of incorrect assembly. The gears typically have position sensor target features that are integrated into the gears and thus the orientation and accuracy of installation becomes very critical.

What is needed is a system and method for reducing the number of required parts when manufacturing a gear meshing arrangement. In addition, by reducing the gears that are required to be manufactured, the overall costs to manufacture the gears are significantly reduced.

The present invention addresses such a need.

### SUMMARY OF THE INVENTION

A gear meshing system is disclosed. The gear meshing system includes a pair of gears engaged with each other through a first plurality and a second plurality of teeth thereon. Each gear has a mark which is oriented in a predetermined relationship with a timing slot on the gear. Each gear of the pair of gears is identical to the other.

Accordingly, by utilizing a marking scheme in accordance with the present invention the same gear part can be used with multiple shafts and thereby assure accurate meshing/timing upon assembly. Accordingly, the need for additional part numbers will be minimized and excessive part proliferation will be avoided.

### BRIEF DESCRIPTION OF DRAWINGS

FIG. 1 illustrates an enlarged view of a conventional marking scheme for a gear meshing arrangement.

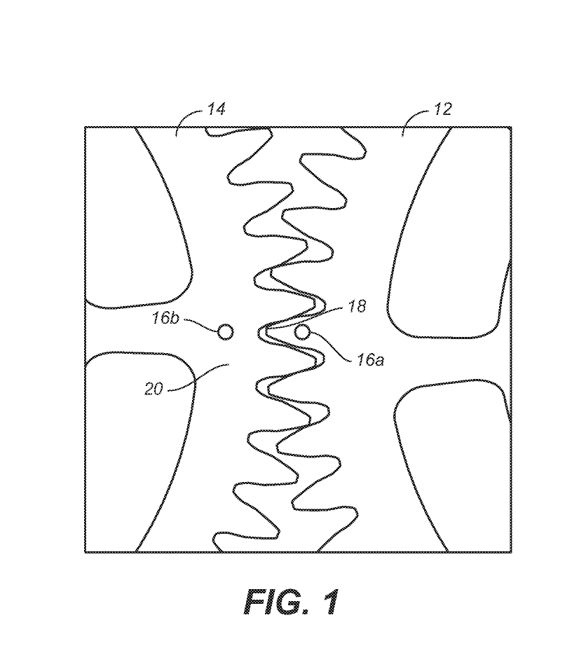

FIG. 2 is a diagram of a gear meshing arrangement in accordance with the present invention.

FIG. 3 shows an enlarged view of the gear mesh arrangement of FIG. 2.

### DETAILED DESCRIPTION

The present invention relates generally to gear assemblies and more particularly to ensuring proper assembly of a gear meshing arrangement. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

A system and method in accordance with the present invention provides a marking scheme that minimizes the part numbers for a manufacturer when assembling gear meshes. In addition this marking scheme will reduce errors when assembling the gear mesh. Although a marking scheme in accordance with the present invention will be described in the context of a gear meshing arrangement utilized with a camshaft assembly, one of ordinary skill in the art readily recognizes that this arrangement can be utilized in a variety of environments and that use would be within the spirit of the present invention. For example the marking scheme could be utilized with any size or type of gear mesh the only condition being that some timing issue must be satisfied that is addressed during assembly of the gear mesh.

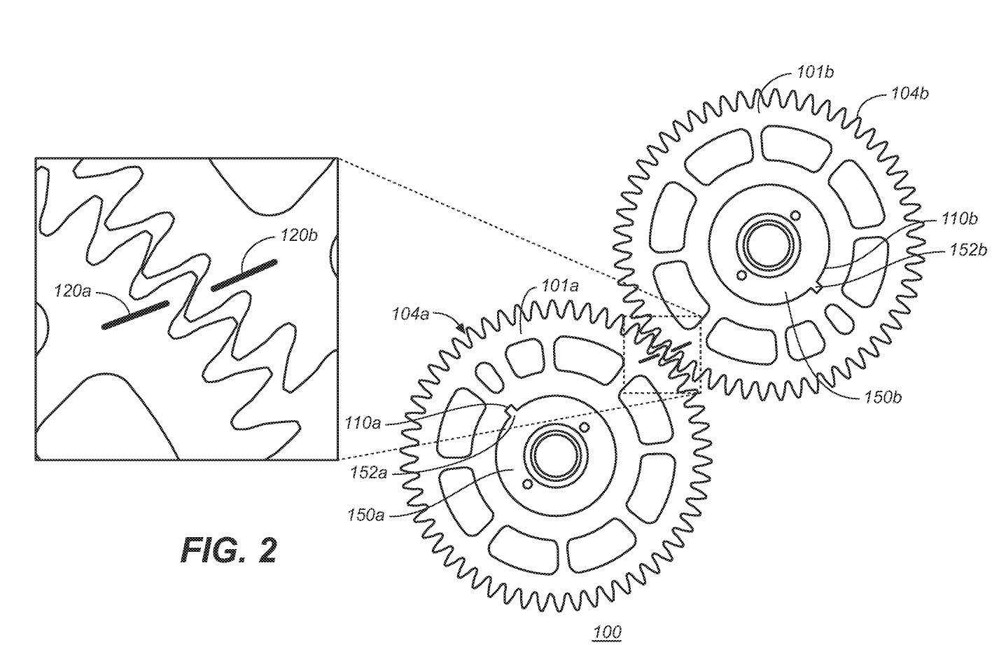

FIG. 2 is a diagram of a gear meshing arrangement 100 in accordance with the present invention. In this embodiment, there is a pair of identical gears 102a and 102b which are engaged with each other. Each gear 102a and 102b includes a plurality of teeth 104a and 104b disposed around a rotating portion 101a and 101b. The teeth 104a and 104b serially engage each other as the gears 102a and 102b rotate. Gears 102a and 102b are attached to camshafts (not shown) via camshaft hubs 150a and 150b. Each of the gears 102a and 102b include a timing slot 110a and 110b for holding a respective timing key or pin 152a and 152b of the camshaft hub 150a and 150b. Additionally each gear 102a and 102b has a mark 120a and 120b that orients the gears 102a and 102b with each other during assembly to ensure that the timing of the camshaft is correct. The marks 120a and 120b, in this embodiment, are diagonal lines which are located at a midpoint within one tooth of the teeth 104a and 104b of each of the gears 102a and 102b. Each of the marks 120a and 120b are oriented such that they are located the same predetermined distance away from their respective timing slots 110a and 110b. As is also seen, the marks are then aligned with each other to ensure there is proper timing of the gear mesh 100 upon assembly. In so doing, each of the gears 102a and 102b can be identical and have the same part number.

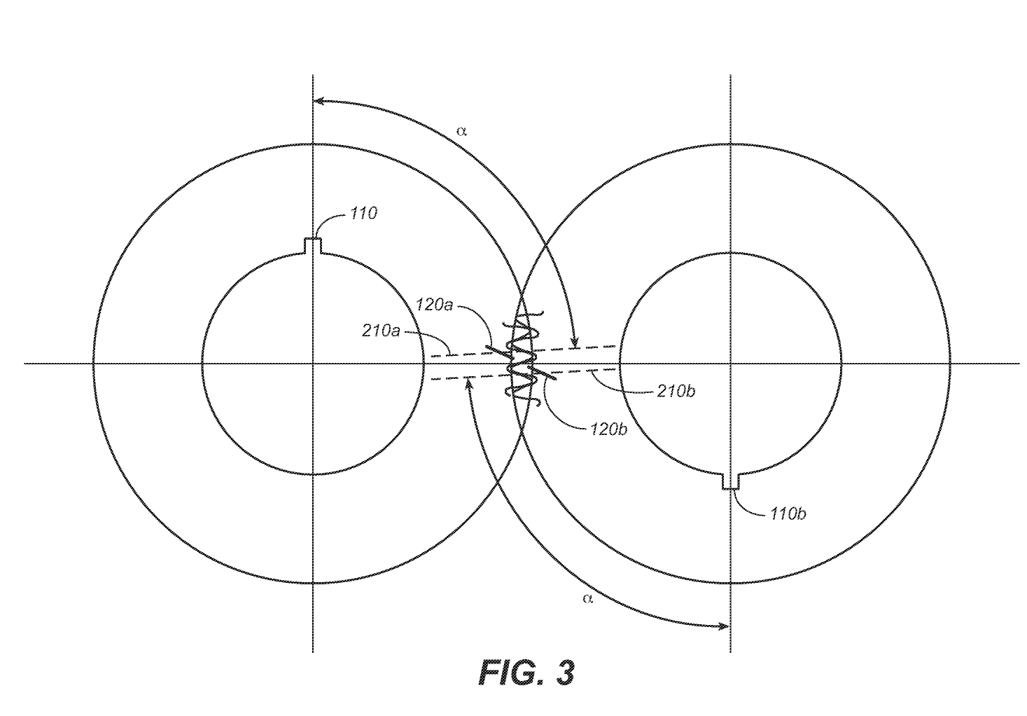

To further illustrate the features of the present invention, refer now to the following description in conjunction with FIG. 3. FIG. 3 shows an enlarged view of the gear mesh arrangement of FIG. 2. As is seen, a center 210a and 210b of the diagonal lines 120a and 120b are equidistant away (a) from the respective timing slot 110a and 110b. This allows for the use of a common part number for both gears while also allowing for ease of assembly. In addition, by utilizing this marking scheme the marks can be placed on both sides of the gears. In so doing, assembly would further be simplified and assembly/service errors are minimized.

Although the marking scheme shown utilizes a diagonal mark as one embodiment one of ordinary skill in the art readily recognizes the mark could be in a variety of configurations including dots, dashes, straight lines, curves, arrows, arrowed lines or other markings. Any of these markings can be oriented with the timing slot of the gear and located on the midpoint of a tooth on the gear to provide the correct orientation when engaged with another gear. Accordingly, this marking scheme allows for a robust gear mesh arrangement that can be utilized in a variety of applications.

Accordingly, by utilizing a marking scheme in accordance with the present invention the same gear can be used with multiple camshafts. Accordingly, the need for additional part numbers will be minimized and excessive part proliferation will be avoided. Finally a marking scheme in accordance with the present invention provides an assembly process that minimizes assembly/service issues.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A gear meshing system comprising:
a pair of gears engaged with each other through a first plurality of teeth and a second plurality of teeth located on the respective gears; wherein each gear has a mark which is oriented in a predetermined relationship with a timing slot on the gear, wherein each gear of the pair of gears is identical to the other.

2. The gear meshing system of claim 1 wherein the mark is located on a midpoint of one of the plurality of teeth on each of the pair of gears.

3. The gear meshing system of claim 2 wherein the mark is any of a diagonal line, a dot, a dash, a straight line, arrows, arrowed line and curves

4. The gear meshing system of claim 3 wherein each of the pair of camshafts include a camshaft hub, wherein the camshaft hub includes a timing key for engaging the timing slot of the respective gear.

5. A gear comprising:
a rotating member;
a plurality of teeth coupled to the rotating member;
a timing slot on the rotating member; and
a mark located on one of the plurality of teeth, wherein the mark is oriented in a predetermined relationship with the timing slot.

6. The gear of claim 5 wherein the mark is located on a midpoint of one of the teeth on the gear.

7. The gear meshing system of claim 5 wherein the mark is any of a diagonal line, a dot, a dash and a straight line.

8. A method for ensuring proper assembly of a gear mesh; the method comprising;
providing a pair of gears engaged with each other through a first plurality of teeth and a second plurality of teeth located on the respective gears;
providing a timing slot on each of the gears;
providing a mark on each of the pair of gears which is oriented in a predetermined relationship with the timing slot; and
aligning the marks of each of the pair of gears with each other to ensure proper timing.

9. The method of claim 8 wherein the mark providing step includes locating the mark on a midpoint of one of the plurality of teeth on each of the pair of gears.

10. The method of claim 8 wherein the mark is any of a diagonal line, a dot, a dash, a straight line, arrows, arrowed line and curves

11. The method of claim 8 which includes engaging the pair of gears with a pair of camshafts.

12. The method claim 11 wherein each of the pair of camshafts includes a camshaft hub, wherein the camshaft hub includes a timing key for engaging the timing slot of the respective gear.

13. A system comprising:
a pair of gears; each of the gears including a rotating member; a plurality of teeth coupled to the rotating member; a timing slot on the rotating member; and a diagonal line mark located on at a midpoint of one of the plurality of teeth, wherein the diagonal line is oriented in a predetermined relationship with the timing slot, wherein the diagonal line on one of the pair of gears is aligned with the diagonal line of the other of the pair of gears to ensure proper timing; wherein each gear of the pair of gears is identical to the other; and
pair of camshafts; each of the pair of camshafts include a camshaft hub, wherein the camshaft hub includes a timing key for engaging the respective timing slot of the pair of gears.
